(19) United States
(12) Patent Application Publication
(10) Pub. No.: US 2004/0261320 A1
(43) Pub. Date: Dec. 30, 2004

(54) Casement window operator system

(76) Inventor: Kevin Francis Sullivan, Eastborne (NZ)

Correspondence Address: Blakely Sokoloff, Taylor & Zafman, 7th Floor, 12400 Wilshire Boulevard, Los Angeles, CA, 90025, US

(21) Appl. No.: 10/495,552

(22) PCT Filed: Nov. 11, 2002
(86) PCT No.: PCT/NZ02/00244

(30) Foreign Application Priority Data
Nov. 12, 2001 (NZ) 515372

(51) Int. Cl. E05F 11/28

(52) U.S. Cl. 49/345

(57) ABSTRACT

A casement window operator system which includes an operator (12), a driven hinge (10) and a passive hinge (11). The driven hinge (10) and the passive hinge (11) are mounted to opposite sides of the frame F of a casement window. The sash S of the window is mountable by the mounting plate (17) and (28) of the hinges. The operator (12) is mounted with the frame F adjacent to the driven hinge (10) and a driven arm (20) of the operator (12) is coupled to the window sash mounting plate (17). The passive hinge (11) constructed to replicate the operating locus of the driven hinge (10).

### BACKGROUND TO THE INVENTION

This invention relates to a casement window operator system.

Casement windows fitted with internal flyscreens are preferably opened with an operator. The operator allows the window sash to be moved between open and closed positions without the need to open the flyscreen. Known arrangements currently use a single arm or a dyad operator which is mounted with the window frame and coupled to the window sash. The sash itself is mounted for adjustable opening and closing by the use of conventional two bar or four bar hinges (or window stays as they are often referred to).

Such arrangements, however, require that either the operator mechanism is exposed to view (which is aesthetically unpleasing) or that the sash and frame have complex profiles to accommodate both the hinge/stay mechanisms and the operator. The profiles are therefore generally large and expensive. In addition the multiple pieces of hardware are time consuming to fit and require adjustment to ensure that the operator and hinges function together.

### SUMMARY OF THE INVENTION

It is an object of the present invention to overcome or at least to go some way to overcoming the problems identified above by combining the functions of the operator and the hinges into a single window operator system.

Broadly according to one aspect of the invention there is provided a casement window operator system including an operator, a driven hinge and a passive hinge, the driven hinge including an arm drivingly engaged (“the driven arm”) with the operator said driven arm being pivotally coupled to a sash mounting in a position spaced from the pivot coupling of the driven arm to the operator, the passive hinge being constructed to replicate the operating locus of the driven hinge.

### BRIEF DESCRIPTION OF THE DRAWINGS

In the following more detailed description of the invention reference will be made to the accompanying drawings in which:

FIG. 1 is a plan view of an operator and driven hinge with profiles of a window frame and window sash being shown in dotted detail,

FIG. 2 is a plan view of one embodiment of the passive hinge,

FIG. 3 is a plan view of a second embodiment of the passive hinge, and

FIG. 4 is a plan view of the passive hinge of the second embodiment superimposed over the operator and driven hinge to illustrate the relative positioning of same in a casement window.

### DETAILED DESCRIPTION OF THE PREFERRED EMBODIMENT

The basic elements of the system according to the present invention are a driven hinge 10, which is illustrated in the drawings as being a so-called four bar hinge. Hinge 10 is able to be fitted to either the top or bottom of the window, though generally it will be positioned at the bottom of the window. The top or as the case may be bottom of the window sash S is mounted in the frame F by a passive hinge 11. An operator 12 is mounted to frame F with the driven hinge 10.

The driven hinge 10 includes a base or mounting plate 13, a long arm 14 pivotally coupled to mounting plate 13 via a pivot or bearing 15. The other end of arm 14 is pivotally coupled by a pivot or bearing 16 to a sash mounting plate 17. This sash mounting plate 17 is, in use, mounted to the top or bottom of the sash S though generally it will be mounted to the bottom.

The mounting plate 13 is fastened in a conventional manner to the bottom (or as the case may be top) of the window frame F. Also mounted in a conventional manner with the same member of the frame F is the operator 12. In the preferred form of the invention the operator 12 has a projecting mounting plate (not shown) which is fastened to the frame section by suitable mechanical fasteners. The frame mounting plate 13 has a profiled end (that is the end opposite to that to which arm 14 is coupled) which interengages with a complementary profiled portion of the operator mounting plate. The interengagement of the profiled end of frame mounting plate 13 and the operator mounting plate ensures that the frame mounting plate 13 is correctly located and disposed relative to the operator 12.

The operator 12 can be of a conventional construction including a housing 18, a drive shaft 19 (to which a handle not shown) is attached. Rotation of shaft 19 causes a worm gear (not shown) within housing 18 to rotate. The operator can be of the type disclosed in U.S. Pat. No. 5,937,582.

A driven arm 20 is pivotally coupled via a pivot or bearing 21 to sash mounting plate 17. The other end of the driven arm 20 is pivotally mounted with the operator. In the illustrated arrangement, the pivot axis of arm 20 is within the housing 18. This end of the arm 20 has a toothed profile formed with it or attached to it. The toothed profile meshes with a worm gear of the operator 12. The worm gear is coupled to the drive shaft 19 and is thus rotated by the shaft 19 being turned by the operator handle.

In the preferred form of the invention a support pad 22 is interposed between the arm 20 and the frame mounting plate 13 or the element of frame F to which the mounting plate 13 is attached. This support pad 22 thus provides support over a significant part of the length of the arm 20 when the driven arm fully projects from the window frame in the fully opened position of the sash.

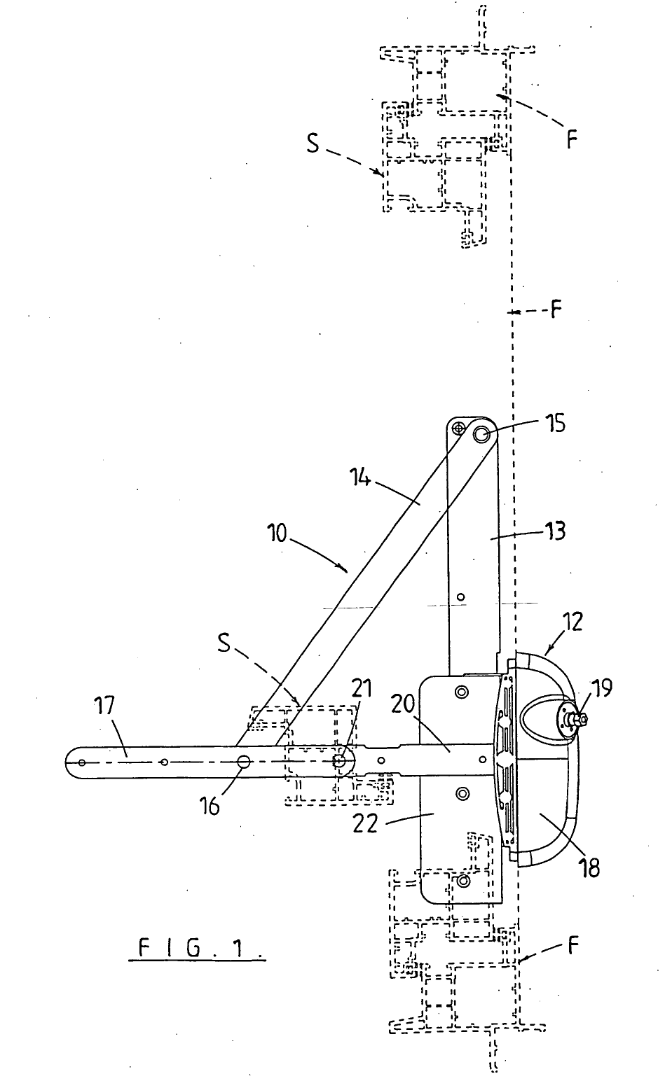

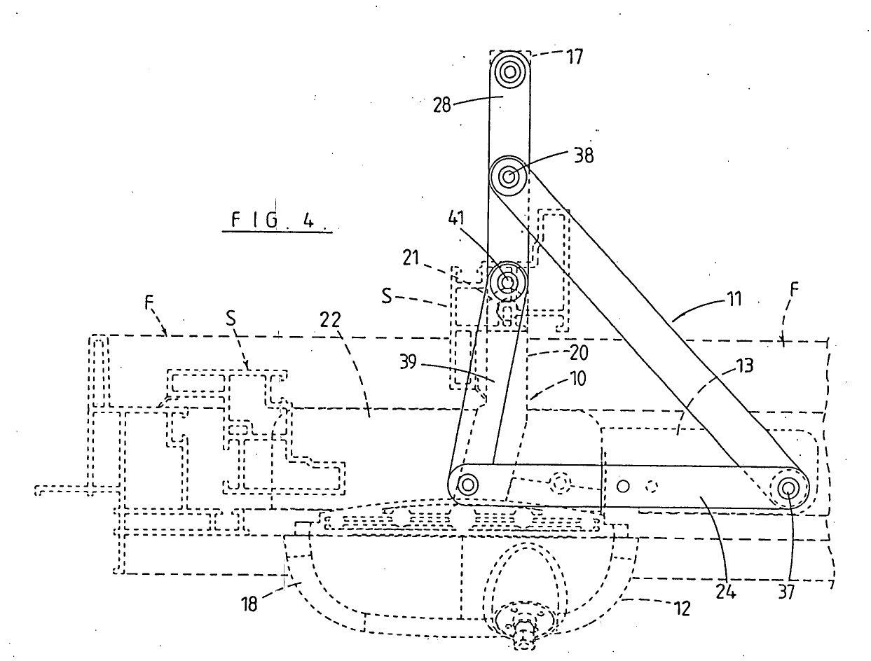

FIGS. 1 and 4 shown in dotted detail part of the sash S in both the fully closed and fully open positions.

Because casement sashes are often relatively heavy it can often be the case that a high load is applied to the arm 20 especially as the arm is effectively supporting a major part of the weight of the sash. Therefore, in order to support the weight of the sash without significant sash drop the driven arm 20 can, as described, be supported by support pad 22. However, arm 20 can also can be of a laminated construction. This laminated construction provides sufficient strength and stiffness to support the sash without using excessive material and without the need for difficult metal forming operations.

The frame mounting plate 13, arm 14, sash mounting plate 17 and driven hinge arm 20 are inserted through a standard routing in the frame section to which the driven hinge 10 is mounted. (This routing is standard for a conventional operator through conventionally it will be the operator arm which extends through the routing to be drivingly coupled to the sash S.) The frame mounting plate 13 is then positioned such that the free end interengages with the mounting plates of the operator and is fastened to the frame section.

In order to provide the necessary gear ratio to satisfy the need for moderate to low operating forces the pivot (not shown as it is within the operator housing 18) of the driven link 20 is located outside the conventional window hinge cavity. Because of this the passive hinge 11 is constructed such that it is replicates or closely replicates the operating locus of the driven hinge 10. The passive hinge 11 is, however, of a construction which is contained within the conventional hinge cavity in the upper (or as the case may be lower) frame section of the window frame F.

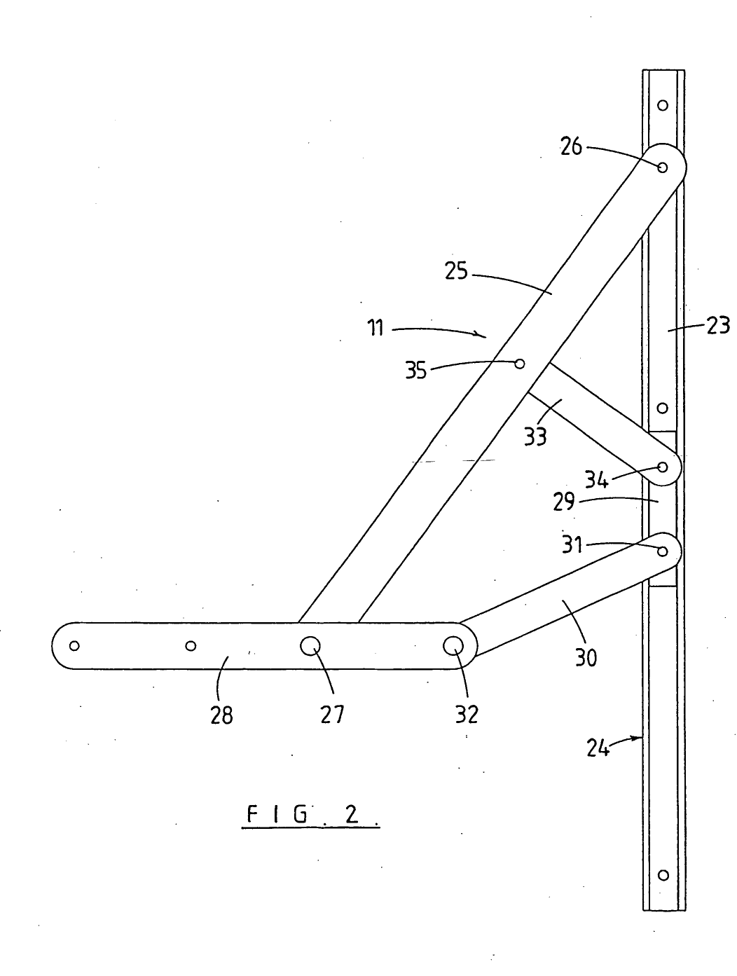

As shown in FIG. 2 the passive hinge 11 can include a frame mounting plate 24 to which is pivotally mounted an arm 25 by a pivot or bearing 26. The other end of arm 25 is attached by a pivot or bearing 27 to a sash mounting plate 28.

The frame mounting plate 24 also provides a carriageway or track 23 on or in which a slide element 29 is slidingly engaged. An arm 30 is coupled by pivot or bearing 31 to the slide 29 and at its other end via a pivot or bearing 32 to the sash mounting plate 28. A further and shorter arm 33 is pivoted at 34 and 35 to the respective slider 29 and long arm 25.

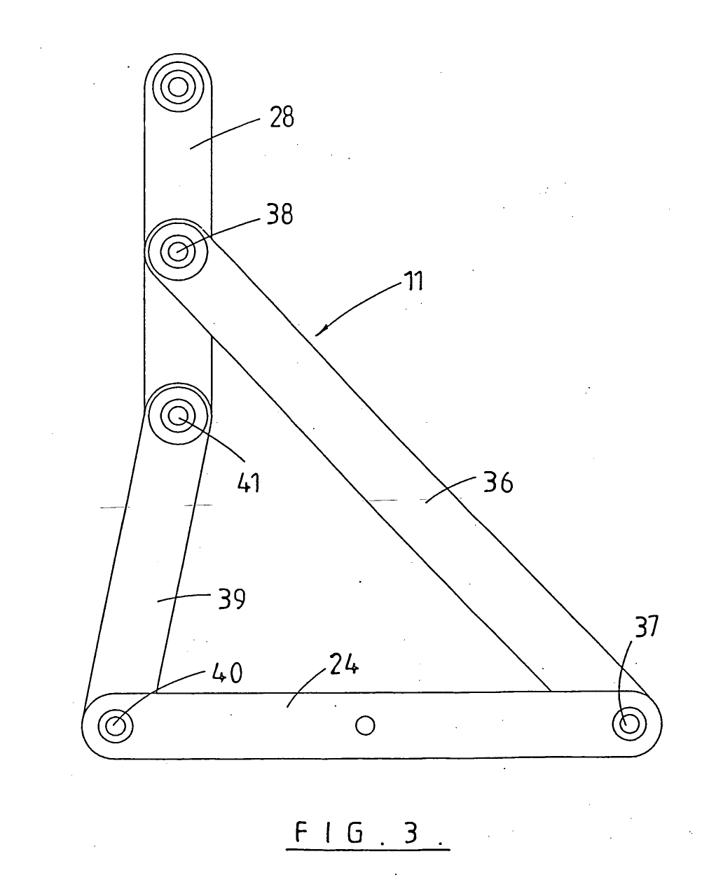

FIGS. 3 and 4 provide an example of a further form of the passive hinge 11. This is in the form of a four bar hinge (stay) having long arm 36 pivotally coupled (37 and 38) at each end to respectively the frame mounting plate 24 and sash mounting plate 28. A short arm 39 is pivotally coupled (40 and 41) at each end respectively to the frame mounting plate 24 and sash mounting plate 28.

FIG. 4 shows the relative positions of the passive and driven hinges and the geometry of the passive hinge relative to the driven hinge whereby the passive hinge emulates the operating locus of the driven hinge.

The geometry including the sliding element 29 provides a complex mechanism which enables the passive hinge 11 to emulate the operating locus of the driven hinge 10. The passive hinge 11 as illustrated and described herein are only by way of example and alternative systems may be employed consisting principally of pivoting links.

The present invention thus provides a combination of operator and driven hinge which can be used with standard or typical window sections. It is simple to mount as effectively it requires a standard routing in the frame section and simple mounting of the operator housing 18 and driven hinge 10 in accordance with known techniques. Likewise the passive hinge 11 involves nothing more than the normal operations associated with the mounting of a hinge to a frame and sash of a window. Therefore, the functions of the operator and the hinges are combined into a single system.

1. A casement window operator system including an operator, a driven hinge and a passive hinge, the driven hinge including an arm drivingly engaged (“the driven arm”) with the operator said driven arm being pivotally coupled to a sash mounting in a position spaced from the pivot coupling of the driven arm to the operator, the passive hinge being constructed to replicate the operating locus of the driven hinge.

2. A casement window operator system as claimed in claim 1 wherein the driven hinge includes a frame mounting plate, an arm pivotally coupled thereto and a sash mounting plate pivotally coupled to the arm said sash plate being pivotally coupled to the driven arm at a distance spaced from the pivot coupling of the sash mounting plate to the arm.

3. A casement window operator system as claimed in claim 1 or 2 wherein the driven arm pivot axis is located within a housing of the operator.

4. A casement window operator system as claimed in claim 3 wherein the pivot axis is, in use, positioned outside a window cavity in which the driven hinge is located.

5. A casement window operator system as claimed in any one of the preceding claims further including a support surface is located adjacent the driven arm to provide support for the driven arm.

6. A casement window operator system as claimed in any one of claims 1 to 5 wherein the passive hinge includes a frame mounting plate, sash mounting plate, a long arm pivotally coupled at each end to respective of the frame and sash mounting plates, a slide element slidingly engaged with the frame mounting and a pair of arms pivotally coupled to the slide end at their respective other ends to the sash mounting plate and the long arm.

7. A casement window operator system as claimed in any one of the preceding claims wherein the driven arm is of a laminated construction.

8. A casement window operator system substantially as herein described and as illustrated in the accompanying drawings.

9. A casement window including a frame and a sash, a passive hinge adjustably mounting one side of the sash to the frame, a driven hinge adjustably mounting a second side of the sash opposite to said first side to the frame, an operator mounted externally of the frame and having an arm (“the driven arm”) which extends through a part of the frame and is coupled to the sash, the passive hinge being constructed to replicate the operating locus of the driven hinge.

10. A casement window as claimed in claim 9 wherein the passive hinge includes a slide element which is coupled to the sash, and the driven hinge includes an arm pivotally coupled at one end to the frame and at the other end to the sash.

11. A casement stay window as claimed in claim 9 wherein the passive hinge is a four bar hinge.

12. A casement window as claimed in claim 10 or 11 wherein the driven arm is pivotally coupled to a mounting plate of the driven hinge and to which the sash is attached.

13. A casement window operator as claimed in claim 10 wherein the driven arm is pivotally coupled to an end of a sash mounting plate of the driven hinge and the arm is pivotally coupled to the sash mounting plate at a distance therefrom.

14. A casement window as claimed in claim 10 wherein the slide is coupled by an arm to a mounting plate to which said one side of the sash is attached, the passive hinge further including a long arm pivotally coupled at one end to the sash mounting plate and the other to a frame mounting with which the slide is slidingly engaged.

15. A casement window as claimed in claim 14 wherein the passive hinge includes a further arm pivotally coupled at one end of the slide and at its other end to the long arm.

16. A casement window operator substantially as herein described with reference to the accompanying drawings.
